(19) United States
(12) Patent Application Publication
(10) Pub. No.: US 2015/0081348 A1
(43) Pub. Date: Mar. 19, 2015

(54) SYSTEMS AND METHODS USING CROWD SOURCED WAIT TIME INFORMATION

(71) Applicants: Scott C. Avera, Cincinnati, OH (US); Scott Miller, Cincinnati, OH (US)

(72) Inventors: Scott C. Avera, Cincinnati, OH (US); Scott Miller, Cincinnati, OH (US)

(21) Appl. No.: 14/463,312

(22) Filed: Aug. 19, 2014

Related U.S. Application Data
(60) Provisional application No. 61/877,717, filed on Sep. 13, 2013.

(51) Int. Cl. G06Q 30/02; G06Q 10/02

(52) U.S. Cl. CPC G06Q 30/0269; G06Q 10/02
USPC 705/5; 705/14.66

(57) ABSTRACT

A system and method of providing crowdsourced wait time information for a venue includes receiving wait time information for a venue from first user, receiving a query about the venue from a second user, determining wait time for the venue based at least in part on the wait time information from the first user, and sending the determined wait time for the venue to the second user. The system and method can also include providing a promotional offer to one or more of the first user, the second user, or the venue. The system and method can also include providing wait time for a second venue in response to the query about the first venue.

### REFERENCE TO RELATED APPLICATIONS

This application claims priority to U.S. Provisional Patent Application No. 61/877,717 filed Sep. 13, 2013, which is herein incorporated by reference in its entirety.

### TECHNICAL FIELD

Embodiments of the technology relate, in general, to managing wait times using mobile technology, and in particular to receiving information from mobile users to manage the wait times of customers and to provide wait time information in results from queries of external sources.

### SUMMARY

In an embodiment, a computer-implemented method of providing wait time information includes receiving an indication of the wait time at a venue from the computing device of a first user, receiving a query about the venue from the computing device of a second user, determining the wait time for the venue based, at least in part, on the wait time information provided by the first user, sending the determined wait time for the venue to the second user, and offering a promotional offer to one or more of the first user, the second user, and the venue. The method can also include receiving an indication of the wait time for a second venue from a third user, determining the wait time for the second venue based, at least in part, on the wait time information provided by the third user, and sending the determined wait time for the second venue to the second user. In configurations, the second venue is in proximity to the first venue, and the wait time of the second venue is less than the wait time of the venue. The method can also include sending wait time information for a plurality of other venues that share a common characteristic with the first venue and that are within a threshold proximity of the venue. In a configuration, one or more graphical elements can be presented on the computing device of the second user. The graphical elements can be indicative of the wait time information for all any or all of the venues, for example the venue and the plurality of other venues. The graphical display elements can be selected from such elements as a color-coded representation of the wait time information, a heat map graphical representation of the wait time information, and bar graph representations of the wait time information. In configurations, a venue can be a restaurant, a bar, an entertainment venue, a service provider, a repair shop, an automotive repair shop, a mechanic's shop, a shopping venue, a government agency, a bureau of motor vehicles, a security checkpoint, a service provider, a physician's office, an attorney's office, a transportation resource, a bus depot, a taxi stand, a ferry dock, an airport, an airline check-in counter, a subway stop, a subway line, a customer service provider, a computer help desk, a telephone support site, a software support site, a network provider, a retailer, or an online service center. The operation of determining the wait time can include obtaining stored user information about the first user, and screening the provided wait time information based, at least in part, on the stored user information about the first user. The operation of determining the wait time can include obtaining stored historical wait time information about the venue, and determining the wait time based, at least in part, on the stored historical wait time information about the venue. The method can further include selecting, by the first user, a wait time for the venue from a selectable list of wait times, and sending the indication of the wait time at the venue that includes the selected wait time. The stored historical wait time information can include a set of wait times from one or multiple users, and the operation of determining wait time can include applying an algorithm to the set of wait time information. For example, a screening algorithm can removed wait times reported by a particular user from the set of wait times. In another example, a sigma bell curve algorithms can remove wait times from the set of wait times based on whether any of the wait time values fall outside of a selected distribution of the sigma bell curve. in another example decay algorithms can remove wait times that fall outside of a selected time window. Determining wait time information can further include obtaining, from third party sources, information that predictably impacts wait time for the venue, and determining wait time information based at least in part on that information. Such information that can predictably impacts wait time includes data such as current weather information, weather forecasts, temperature forecasts, local scheduled activities, concerts, sporting events, reservation system information, transportation schedules, transportation data, economic data, news feeds, and social media postings and messages

In another embodiment, a computer-implemented method of providing wait time information includes receiving a query related to at least one venue from a computing device of a user, obtaining venue information that is responsive to the query, determining the identity of at least one venue from the venue information, obtaining wait time information for the identified venue, associating the wait time information with the venue information, for example by combining the results in a web page format, and sending the venue information and the wait time information to the computing device of the user.

In an embodiment, a non-transitory computer readable medium having instructions stored thereon can be executed by one or more processors and cause the processors to receive wait time information about a venue from a first plurality of users of a crowdsourced wait time management service. The instructions can cause one or more processors to receive from a user, a query about a current wait time for the venue. The instructions can cause one or more processors to determine the current wait time for the venue based at least in part on the wait time information provided by some or all of the plurality of users. The instructions can cause one or more processors to send, to the user, the current wait time of the first venue and provide one or more actions steps to the user related to the venue. In a configuration, the instructions can cause one or more processors to receive an indication of a selected action step by the user, send a message related to the selected action step to the venue, receive a confirmation step from the venue regarding the selected action step, and send a confirmation of the selected action step by the venue to the user. In another configuration, the selected action step can be a request for a reservation at the venue or a request to place the user's name on the wait list of the venue. In another configuration, an action step presented to the user can be used to initiate a call the venue, or send a message the venue to make a reservation or place the user's name on the wait list. In another configuration, communication between the venue and user can be performed directly between the venue and user, for example using SMS messages or a phone call, without using the crowdsourced wait time management system.

### BRIEF DESCRIPTION OF THE DRAWINGS

The present disclosure will be more readily understood from a detailed description of some example embodiments taken in conjunction with the following figures:

FIG. 1 depicts an example wait management system according to one embodiment.

FIG. 2 depicts an example computing device of a wait management system according to one embodiment.

FIG. 3 depicts an example wait management computer system according to one embodiment.

FIG. 4 depicts an example display of an application executing on a mobile device that depicts a menu of selectable wait times for an establishment according to one embodiment.

FIG. 5 depicts an example display of an application executing on a computing device that depicts a plurality of establishments and associated wait times according to one embodiment.

FIG. 6 depicts an example search engine result listing a plurality of establishments, and an associated wait range estimate for each of the plurality of establishments, according to one embodiment.

FIG. 7 depicts an example search engine result listing a plurality of establishments, and an associated wait range estimate for each of the plurality of establishments, according to one embodiment.

FIGS. 8A and 8B depict example operations of a crowdsourced wait time management system, according to one embodiment.

FIG. 9 depicts example communication flows of a crowdsourced wait time management system, according to one embodiment.

### DETAILED DESCRIPTION

Various non-limiting embodiments of the present disclosure will now be described to provide an overall understanding of the principles of the structure, function, and use of crowdsourced wait time management systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of computer-based systems and methods for determining wait times using crowdsourced information. In one example embodiment, wait time information can be received from one or more wait time information providers. In some embodiments, one or more requests to access the wait time information can be received from at least one consuming device. In some embodiments, wait time information can be provided based on reported wait times or estimated wait times and messaging, such as advertising, can be delivered to influence the decisioning in tandem with or separately from the wait time information. Crowdsourced information on wait times can be screened, curated, compared against norms, compared against competitors, or can otherwise be managed for presentation to a user or for analytic purposes. It will be appreciated that methods of screening wait times are shown by way of example only, where screening any suitable data based on crowdsourced data, external data, or combinations thereof is contemplated. It will be appreciated that methods of estimating wait times are shown by way of example only, where estimating any suitable data based on crowdsourced data, external data, or combinations thereof is contemplated. In example embodiments, an organization such as a restaurant can be rewarded for crowd reporting activity or for encouraging crowdsourced data submissions. In example embodiments, wait time information can be provided in conjunction with search results, such as in conjunction with a search engine or search engine query display. For example, when querying a restaurant, a search engine can populate an estimated wait time in proximity to other relevant information about the establishment obtained by the query such as address, name, and guest reviews.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can provide accurate wait time estimates using both internal and external information about a location. For example, a wait management system can provide estimates as opposed to fixed wait times, can use external data to influence wait time estimates, can screen externally reported wait times as indicated by a user, can produce messaging to influence a user's behavior in tandem with wait time information, can produce messaging to influence a user's behavior based on wait time information, can reward organization owners for crowd reporting, and can provide wait time information to third party queries such as search engines. It will be appreciated that the wait time management system can be associated with any suitable organization, or venue, where customers typically experience wait times for service, such as restaurants, entertainment venues, bars, automotive repair shops, shopping venues, government agencies such as the bureau of motor vehicles, security checkpoints, service providers such as physicians, mechanics, and attorneys, transportation resources such as bus, taxi, train, ferry, air or subway lines, any customer service providers such as computer help desks, software support, broadband providers, retail or online service centers, repair and service scheduling, and the like.

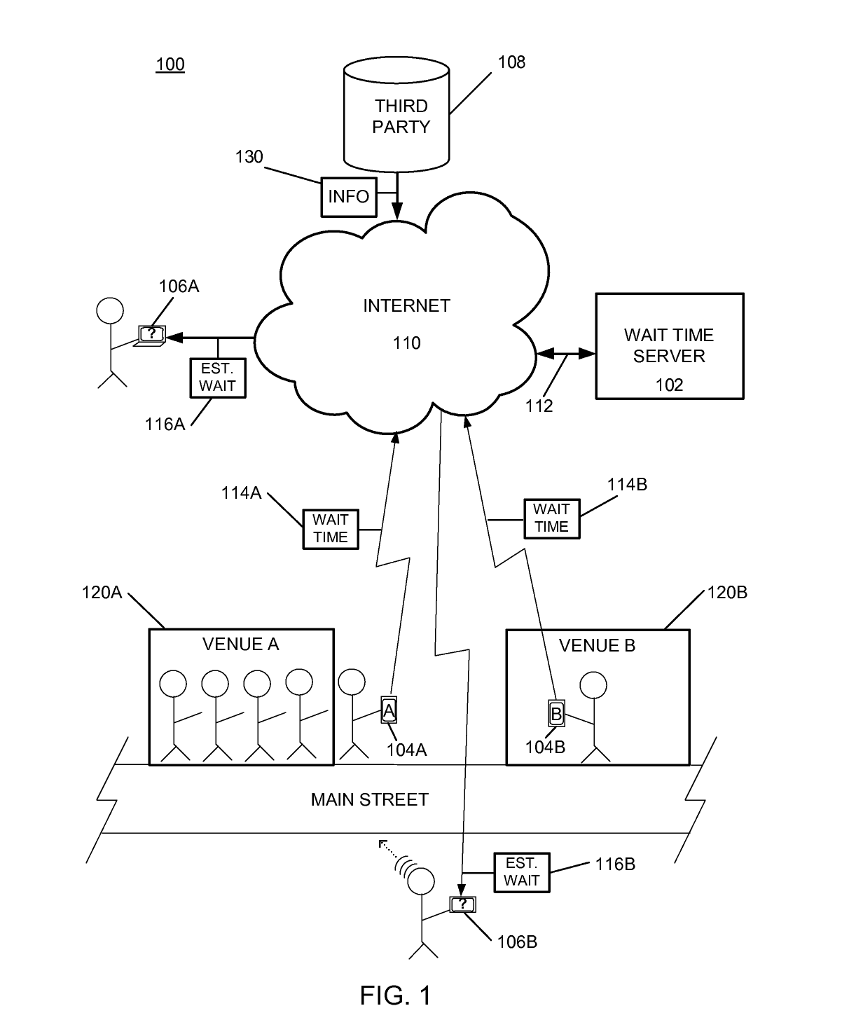

Referring to FIG. 1, an embodiment of a wait management system 100 can include a wait management computer system 102 that can execute software for the estimation of wait times. The wait management computer system 102 can receive notifications 114A, 114B (collectively notifications 114) of wait times at venues 120A, 120B (collectively venues 120). The notifications 114 can be sent to the wait management computer system 102 by applications, or apps, executing on mobile devices 104A, 104B (collectively mobile devices 104). The wait management computer system 102 can use the notifications 114 to compute, derive, or otherwise determine estimated wait times for each of the venues 120. The wait time estimates 116A, 116B (collectively wait time estimates 116) can be sent to computing devices 106A, 106B (collective computing devices 106) of other users. The wait management computer system 102 can also obtain information 118 from other third party information sources 108 and use that information 118 to determine the estimated wait times for the venues 120. In some embodiments, the wait management system 100 can integrate with various types of systems, such as OpenTable™, online reservation systems, and the like.

Other communications 112 between the mobile devices 104, computing devices 106, and wait management computer system 102 are also contemplated, as would be understood by one of ordinary skill in the art, but are not shown for simplicity of exposition. For example, wait time queries can be received from the computing devices 106, updated wait time estimates can be sent back to the mobile devices 104, promotional offers can be sent to either or both the mobile devices 104 and the computing devices 106 (for example rewards to mobile devices 104 for providing the wait time estimates 116, or coupons to the computing devices 106 to influence user behavior).

The wait management computer system 102 in accordance with the present disclosure can be accessed via any suitable technique, such as a web-browser such as Safari™, Opera™, Google™ Chrome™, Internet Explorer™, or the like executing on a client device such as a mobile devices 104 or computing devices 106. The application executing on a mobile device 104 or other computing device 106 can be a web-based application or a stand-alone executable. The mobile devices 104, computing devices 106, and wait management computer system 102 can communicate using any suitable communication channels and protocols, for example all of the devices of the wait management system 100 can use the Internet 110, as shown, as their communication network. Other suitable communication channels and protocols can include, without limitation, those used in mobile wireless communications and wired networked connections.

For example, one or more individuals at a first venue 120A can execute a mobile app on their mobile device 104A and send a notification 114A of the wait time at the first venue 120A. Another individual at a second venue 120B can similarly execute a mobile app on their mobile device 104B and send a notification 114B of the wait time at the second venue 120B. The wait time computer system 102 can store the received notifications 114 and use them to provide wait times estimates 116 in the future. When a user of a computing device 106 sends a query about the wait time for one of the venues 120 to the wait time computer system 102, the wait time computer system 102 can determine and send a wait time estimate 116. For example, a user of a personal computing device 106A at work or home can receive wait time estimates 116A in the results returned from an Internet search of nearby restaurants. In another example, a user travelling towards a group of popular bars can use a mobile app executing on a mobile computing device 106B to send a query to the wait time computer system 102 in order to determine if any of the venues 120 currently have wait times or are predicted to have wait times. In the example situation illustrated in FIG. 1, the user may be travelling towards a first venue 120A and receive wait time estimates 116B that indicate that the first venue 120A has a long line of patrons waiting to get in, while a second venue 120B may have no line or a shorter wait time. The user can use the wait time information in making a decision whether to continue to the first venue 120A or to change direction and go to the second venue 120B instead.

The wait time estimates 116 can be used by different users to provide different information. For example, some users may be looking for restaurants where they can be seated quickly. Other users may use the wait time estimates 116 to determine which venues are the most popular. Still other users may use the wait time estimates 116 to determine ideal times to arrive at a venue to beat the crowd, or to determine which venues 120 will require reservations in advance. The architecture of the wait management system 100 is designed to be flexible and configurable in order to provide the desired wait time information to each of the users.

The wait management computer system 102 can run on any suitable computing system, such as a dedicated server, a personal computer, a server, multiple computers, a collection of networked computers, a cloud-based computer system, a web-based computer system, or from a storage device, for example. One or multiple processing units, such as central processing units and/or graphics processing units, may perform instructions stored in memory to execute the processes described herein. Any suitable client device can be used to access, or execute, the wait management computing system 102, such as laptop computers, desktop computers, smart phones, tablet computers, gaming system, and the like.

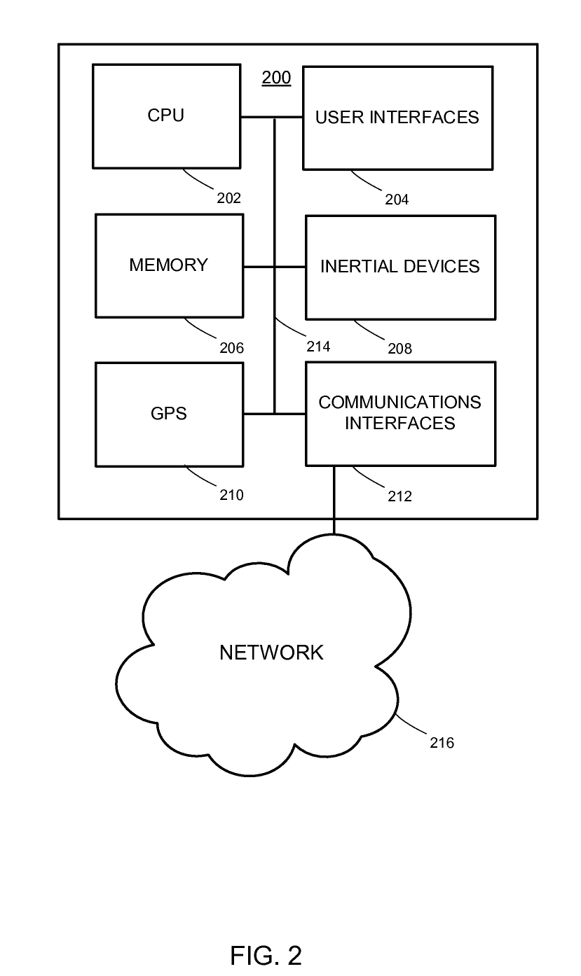

Referring now to FIG. 2, an example computing device 200 is presented. The processes described herein can be performed on or between one or more computing devices 200. A computing device 200 can be a server, a computing device that is integrated with other systems or subsystems, a mobile computing device, a cloud-based computing capability, and so forth. The computing device 200 can be any suitable computing device as would be understood in the art, including without limitation, a custom chip, an embedded processing device, a tablet computing device, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

Each computing device 200 includes one or more processors 202 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 200 also includes one or more memories 206, for example read only memory (ROM), random access memory (RAM), cache memory associated with the processor 202, or other memories such as dynamic RAM (DRAM), static ram (SRAM), programmable ROM (PROM), electrically erasable PROM (EEPROM), flash memory, a removable memory card or disk, a solid state drive, and so forth. The computing device 200 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 202, or memories 206 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 212 can be configured to transmit to, or receive data from, other computing devices 200 across a network 216. The network and communication interfaces 212 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 212 can include wired data transmission links such as Ethernet and TCP/IP. The communication interfaces 212 can include wireless protocols for interfacing with private or public networks 216. For example, the network and communication interfaces 212 and protocols can include interfaces for communicating with private wireless networks 216 such as a WiFi network, one of the IEEE 802.11x family of networks, or another suitable wireless network. The network and communication interfaces 212 can include interfaces and protocols for communicating with public wireless networks 216, using for example wireless protocols used by cellular network providers, including Code Division Multiple Access (CDMA) and Global System for Mobile Communications (GSM). A computing device 200 can use network and communication interfaces 212 to communicate with hardware modules such as a database or data store, or one or more servers or other networked computing resources. Data can be encrypted or protected from unauthorized access.

Mobile computing devices can include inertial components 208 and global positioning systems components (GPS components 210). The inertial components 208 and GPS components 210 can determine the terrestrial position of the mobile computing devices. Mobile computing devices can use the inertial components 208 and GPS components 210 in combination with radio transmissions received via the network and communication interfaces 212 to accurately determine the position of a mobile computing device. The position can be transmitted to other computing systems. For example, the position of a mobile computing device can be transmitted to the wait time computer system 102 and used to determine venues 120 proximate to the mobile computing device.

In various configurations, the computing device 200 can include a system bus 214 for interconnecting the various components of the computing device 200, or the computing device 200 can be integrated into one or more chips such as programmable logic device or application specific integrated circuit (ASIC). The system bus 214 can include a memory controller, a local bus, or a peripheral bus for supporting input and output devices 204, and communication interfaces 212. Example input and output devices 204 include keyboards, keypads, gesture or graphical input devices, motion input devices, touchscreen interfaces, one or more displays, audio units, voice recognition units, vibratory devices, computer mice, and any other suitable user interface.

The processor 202 and memory 206 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

Systems and methods described herein may generally provide a real time wait management environment for users, such as those waiting to enter a restaurant, to more accurately predict wait times and influence behavior. Influencing behavior can include providing a user with options in conjunction with or based on wait time (i.e. capacity) information. For example, when a user uses the wait time management system 100 to obtain current wait times at establishments, or venues, they are interested in attending, the user can receive advertisements alerting them to special offers by those establishments. Participating establishments can provide a user with a promotional offer such as a discount, coupon, voucher, or the like for their establishment (e.g., a free appetizer). The participating establishments can configure a promotional offer to be contingent upon certain conditions. For example, a promotional offer may only be offered if a competitor's wait time exceeds one hour. Promotional offers can be used to pacify those waiting in long lines or to lure to a participating restaurant those customers that are waiting for a competing restaurant. Participating establishments can also advertise additional services, offerings, events, or specials while a patron waits. For example, an establishment with a two hour current wait could let users know they are currently experiencing long wait times but to check out their “Jazz” night on Tuesdays when they typically have no wait.

Wait time information can also be used internally by an establishment, where an owner could decide to extend the hours of operation for a given evening based upon wait time information for the establishment or a competitor's establishment. An establishment can use wait time information to schedule service and support when wait times exceed certain parameters, for example a large public entertainment venue can use wait time information to schedule police and fire services required by law. In addition to receiving wait time information, a venue can send wait time information to the wait management computer system 102. The venue can send the current wait time to keep patrons informed about their expected wait. The venue can also send estimated wait times for future dates, such as when the venue is hosting a private party or when the venue can estimate wait times based on reservations that have been made.

Interaction with the wait management system may include, without limitation, keyboard entry, writing from pen, stylus, finger, or the like, with a computer mouse, or other forms of input (voice recognition, etc.). The wait management system may be presented on a tablet, desktop, phone, board, or paper. In one embodiment, the user may interact with a wait management system by writing with a smart pen on normal paper, modified paper, or a hard flat surface of their preference. In embodiments, the user may receive real-time feedback, or at least near real-time feedback, or may synchronize with a wait management computer system at a later time.

User interaction with the wait management computer system 102 may take place in any of a variety of operational environments, such as a work setting, restaurant setting, entertainment venue setting, or a home setting, with one or more users or venues interacting with the wait management computer system 102 at a given time. In a configuration, a venue can be a user of the wait management computer system 102, which allows the wait management computer system 102 to treat both users and venues as users. A manager or employee of the venue can enter wait time estimates, manage rewards, and so forth. In this way, venues can periodically update wait time information about their establishments.

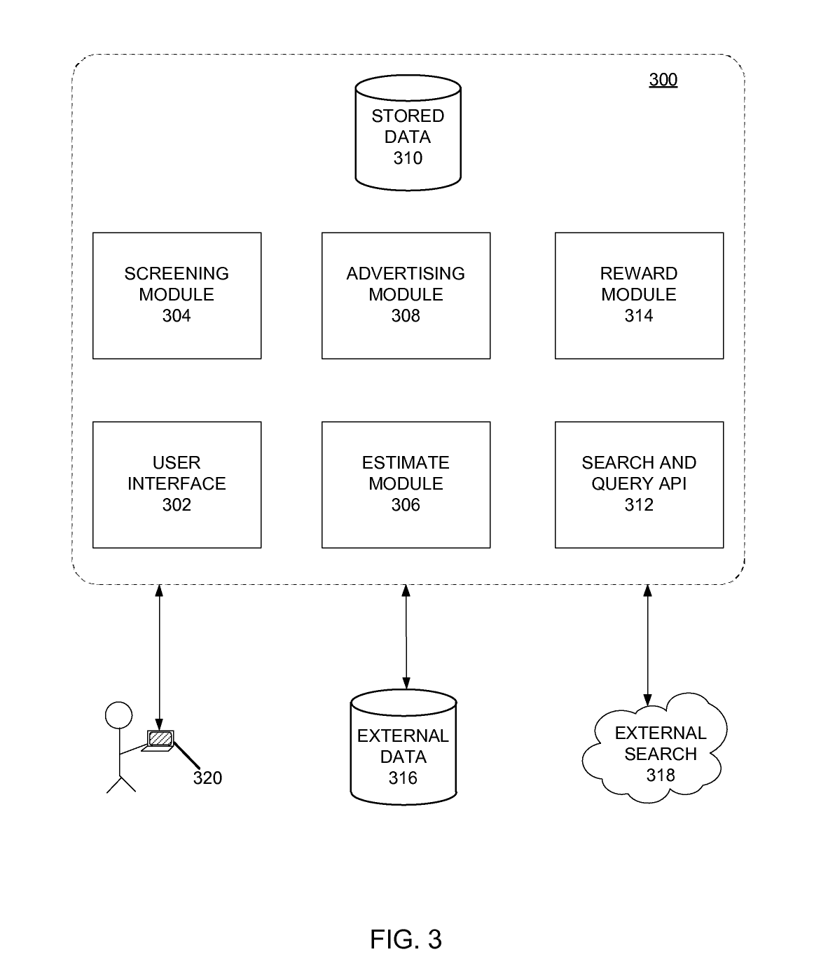

Referring now to FIG. 3, example components of one embodiment of a wait management computing system 300 are depicted. Components can include either or both software and hardware modules. The wait management computing system 300 can include one or more types of user interfaces 302. In various configurations, some or all of the user interfaces can execute on user equipment 320. For example, a user interface can be an application or app designed to execute on user equipment 320, for example a user's mobile computing device, tablet, or smartphone. Another example user interface 302 can be software executing on the wait management system 300 that serves webpages that are delivered to user equipment 320 and displayed on a web browser executing on a smartphone, a desktop computing device, or notebook computing device. In another example, a user interface 302 can be a dedicated application designed to execute on user equipment 320 such as a personal computing device.

User Equipment 320 can generally include any computing device that has a CPU and the ability to send and receive data with the wait management computing system 300 that can communicate wait times with the wait management system 300. For example, in a configuration, a dedicated reservation system can be considered user equipment 320. In addition to sending information about wait times, the user interface 302 can provide messaging capabilities, allow users to send and receive information with establishments to manage their wait times, upload notifications to social networks about user activity, allow users to configure and control preferences, allow users to see and redeem reward for user activity, or for any other suitable purpose as would be understood in the art. Example messaging between the wait management computing system 300 and user equipment can include, but is not limited to, SMS, EMS, MMS, smart messaging, e-mail, banner advertisements, pop-up notifications, push alerts, cookies, XML, HTLM, webpages and the like.

The wait management computing system 300 can include a screening module 304 that can include screening algorithms for determining the validity of data being submitted by users, venues, or from any other source. The screening module 304 can use any suitable factor such as inputs outside of historical ranges, inputs varying widely from other user inputs, input patterns varying widely from other user input patterns, inputs coming from locations too distant to each other, inputs varying too much for a given period of time, inputs varying widely from certified data from other sources, or inputs coming from suspect devices. For example, the screening module 304 can allow only a certain number of submissions per time period for each unique submitting device, can allow only submissions that, given recently submitted data, are viable given the passage of time and statistical confidence of data recently submitted, can allow only submissions that, given historical data, are viable given the statistical confidence of data historically submitted, or can allow only submissions that given the distance between locations can viably be reported in a given period of time. In configurations, users who are found to have submitted data that has been rejected by the screening module 304 a predetermined or threshold number of times can have their past, present, or all submissions automatically flagged as rejected.

In a configuration, the screening algorithms of the screening module 304 can be used to detect and eliminate anomalous or misleading entries or inputs that could result in incorrect wait time projections. For example, an establishment may experience ten user-reported wait times within a 30 minute period that indicate a wait time from 25-40 minutes. An 11^{th} reported wait time from a user may indicate a wait of 130 minutes, which can be rejected by the screening module 304 based upon a +−3 sigma bell curve of expected results. In another configuration, an establishment's wait time may be reported by three users as indicating a wait time of 45 minutes. Shortly thereafter, another user may indicate a wait of “0 minutes”. Since the original wait of 45 minutes should not have improved much more than to 40 minutes 5 minutes after reported, the “0 minute” single report wait time can be rejected by the screening module 304. In another configuration, the screening module 304 can note inputs from a specific device that are spurious, where the IP address, or other suitable indicator, of the device can be flagged such that inputs from that device are not factored into the wait calculation. In another configuration, it is noted a specific device reports over many days always on one specific establishment or a small set of establishments and always materially differing wait times than other reports. This device is can be flagged for exclusion and all past and future data can be ignored in calculations. The data can be stored in the data store 310 or any other suitable networked or local storage means.

A data store 310 can be a repository of data related to wait times submitted by users, personal user information, use history, establishment information, geographic position, or any other suitable information. The data stored in the data store 310 can be screened by the screening module 304 before being used by the other software modules of the wait management system 300, such as the advertising module 308, the reward module 314, and the estimate module 306.

The wait management computing system 300 can include an estimate module 306. The estimate module 306 can include one or more estimating algorithms to estimate the current wait time for a venue, such as a restaurant or entertainment venue. An estimating algorithm can take into account any suitable factor such as inputs of time, historical data, external conditions, known influencing events, known patterns, or related reported data. Suitable data can be obtained from the data store 310, retrieved from sources of external data 316, or queried using the search API 312. Example methods of estimating wait times can include estimating the current wait time based on the passage of time and statistical confidence of data recently submitted, estimating current wait time based on an average of the most recently reported wait times, estimating current wait time based on historical data, patterns, and the statistical confidence of data historically submitted, estimating current wait time based on input from a neural network trained on each organization's wait time history and big data, or combinations thereof. Estimates for wait times occurring in the future can similarly be computed.

In an example, five users could input wait times of +−30 minutes from the current time on Tuesdays over the last four weeks. These wait times might average 25 minutes, which can be reported to a user as the estimated wait time in conjunction with the last actually reported wait time, which might be “20 minutes” reported five minutes prior. In this manner, the historic data can be combined with near real-time user input. A synopsis of the historic data can be included in the estimate. For example, if a wait time has not been reported for more than two hours, the reported wait time can be indicated as “0” and no reported wait time occurring for over 2 hours. In another example, a single wait time of 20 minutes may be reported within 5 minutes of the current time but no other wait time data for the particular establishment may exist. The reported wait time is indicated as 20 minutes “reported 5 minutes ago” and no estimated wait time is indicated. In another example, no reported wait time has been reported for more than two hours, yet during the same period for the same day of the week on the prior 4 weeks the wait time has averaged 20 minutes. The estimated wait time is reported as 20 minutes.

In another example, a wait time of “20 minutes” might be reported by a user 15 minutes prior to the current time. Historical information can be used to determine the probable decay rate of the wait queue and, given the day of the week and time of day, it can be calculated that the queue should improve by five minutes given the data. Thus a 15 minute estimated wait time can be reported in contrast to the “20 minute” reported wait time. In an example, only historical data may be available for an establishment at 6:30 PM on a Tuesday, where no users have input wait times. However, weather information can be combined with the historical data which may show that on sunny days, where the temperature is between 70-80 degrees, the wait typically doubles. Given the example day's weather is sunny and 75 degrees, the average historical wait time can be doubled and then reported. In another example, the dates of local festivals, events, shows, or the like, can be combined with wait times for local establishments. The data may indicate that when local events are scheduled, wait times increase by 50%. Thus, historical averages can be inflated by 50% during event periods. In another example, user reported wait times can be rank ordered based on their distance in time from the then current day of the week and time of day. For example, all values within +−10 minutes of the then current day of the week and time of day may be included in the historical average calculation. If less than five values or inputs compose the dataset +−10 minutes from the then current day of the week and time of day, for example, values up to +−60 minutes from the then current day of the week and time of day can be added to the average calculation until it includes five values or all the values available +−60 minutes from the then current day of the week and time of day if less than five values are available.

In an example configuration, the estimate module 306 of the wait management computing system 300 can determine, based on a predetermined set of factors such as the aforementioned factors, the best estimates, or combination of estimates. Estimates can be displayed to the user by the user interface 302 either in contrast to or as a replacement for the most recently reported wait. In addition to estimates, the wait management computing system 300 can forward the actual wait times reported by other users, either in combination with estimates, in place of the estimate, or as the estimate. The wait management computing system 300 can provide estimates for multiple establishments. In an example configuration, the user equipment 302, for example a user's smartphone, can report its position and the wait management computing system 300 can determine a list of all establishments within 1 mile to be sent to the user interface 302 on the user's smartphone with each establishment ranked from the lowest reported wait time to the highest and with each entry showing the estimated wait time for each establishment. This information can be updated each time the user accesses wait management computing system 300, or can be updated periodically. In another configuration, the user can set a preference to be notified by a SMS text message whenever the reported wait at a specific establishment falls below a threshold, for example when an establishment has a reported or estimated wait of 10 minutes or less. In another configuration, information can be delivered by push data to the user equipment 320, such as the user's phone.

The wait management computing system 300 can also obtain external data 316 for use in determining wait estimates or determining when to communicate with users. External data 316 can be any suitable source of data that can influence the calculations and determinations of the wait management computing system 300. The external data 316 can be any suitable factor such as current, past, or future conditions, activities, or identifiers. In an example configuration, external data 316, such as temperature, location, business type, local event schedules, number of tweets or other social activity indicators about a topic or place, posted in-season dates from chamber websites, transportation data such as number of flights, local or business type economic statistics, macro-economic statistics, news feeds, wait time information from other sources such as reservation systems, or the like, can be obtained. The external data 316 can be manually input into the wait management system 300 or electronically obtained. The external data can be screened by the screening module 304.

The wait management computing system 300 can also include a search/query application programming interface or search/query API 312 that can be used to perform queries on the Internet, search external data sources, or otherwise perform external searches 318. The search/query API 312 can provide wait time information that is displayed to users in the results returned from queries or the information can be used in calculations. The search/query API 312 can provide reported, estimated, historical, and/or third party wait time information to external queries including search engines such as Google™, Bing™, Yahoo!™, other systems or devices requesting such information like any suitable ecommerce or online reservation systems such as OpenTable™, Rezbook™, or devices such as standalone pagers, which are hereby presented as non-limiting examples only. It should be noted that although accessing the information is depicted via the search/query API 312, accessing the information in other ways including screen scrapping, searching an intermediary database, and so forth, is also contemplated.

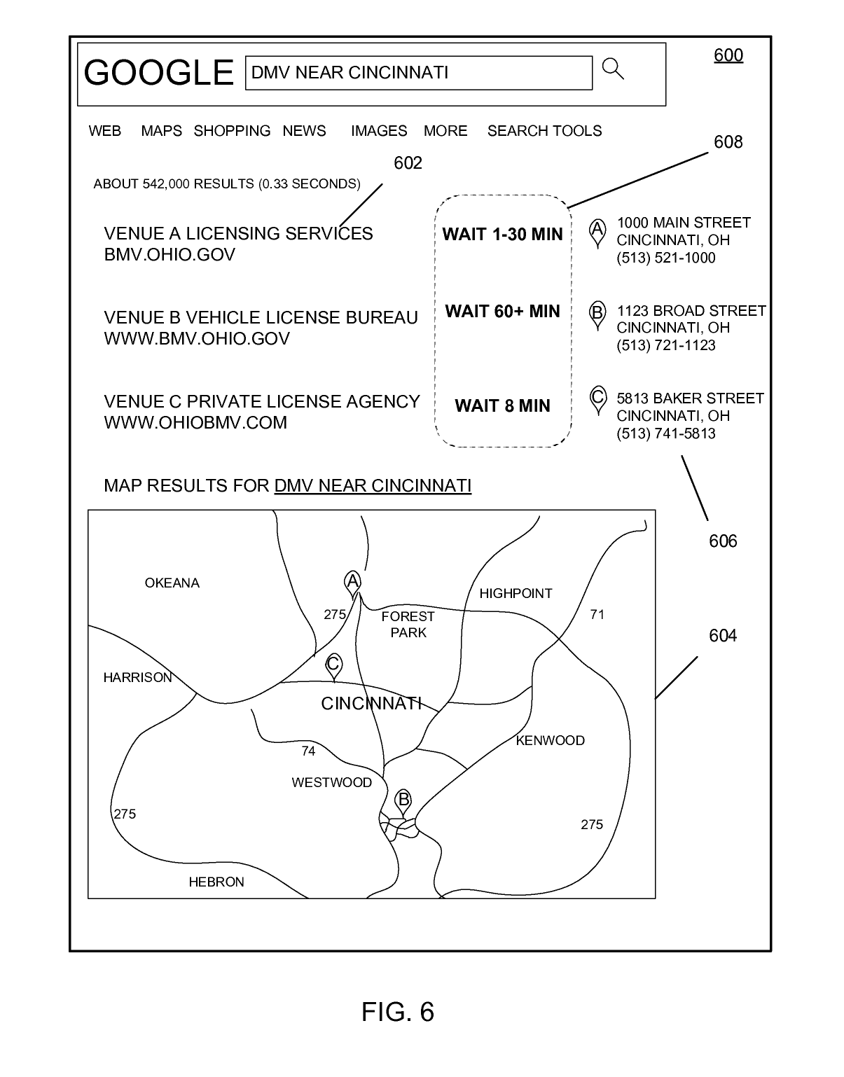

Wait time information can be presented along with the results of the query in any number of suitable ways, as would be understood by one of ordinary skill in the art. For example, a user using a search engine such as Google™ to search for information on a specific restaurant can be presented with search results that also include the current reported, estimated, historical, and/or third party wait times. A user using a search engine such as Google™ to search for information about license bureaus in proximity to a particular town or city can be presented with the results of the query that are supplemented to include estimated wait ranges for all of the matching results. Referring now to FIG. 6, an example of a supplemented search result is presented. In this example, a user has searched for motor vehicle licensing bureau. Google™ has returned as results a list of bureaus 602 that are in the area as well as a map 604 and addresses 606 for each matching result. The search/query API 312 can supplement the results of the search with wait time information 608 from the estimate module 306. The search results can include the supplemental wait time information 608 in the results. In a configuration, the supplemental wait time information can be overlaid or otherwise added by the user interface 302 without modifying the search results returned from the external search 318.

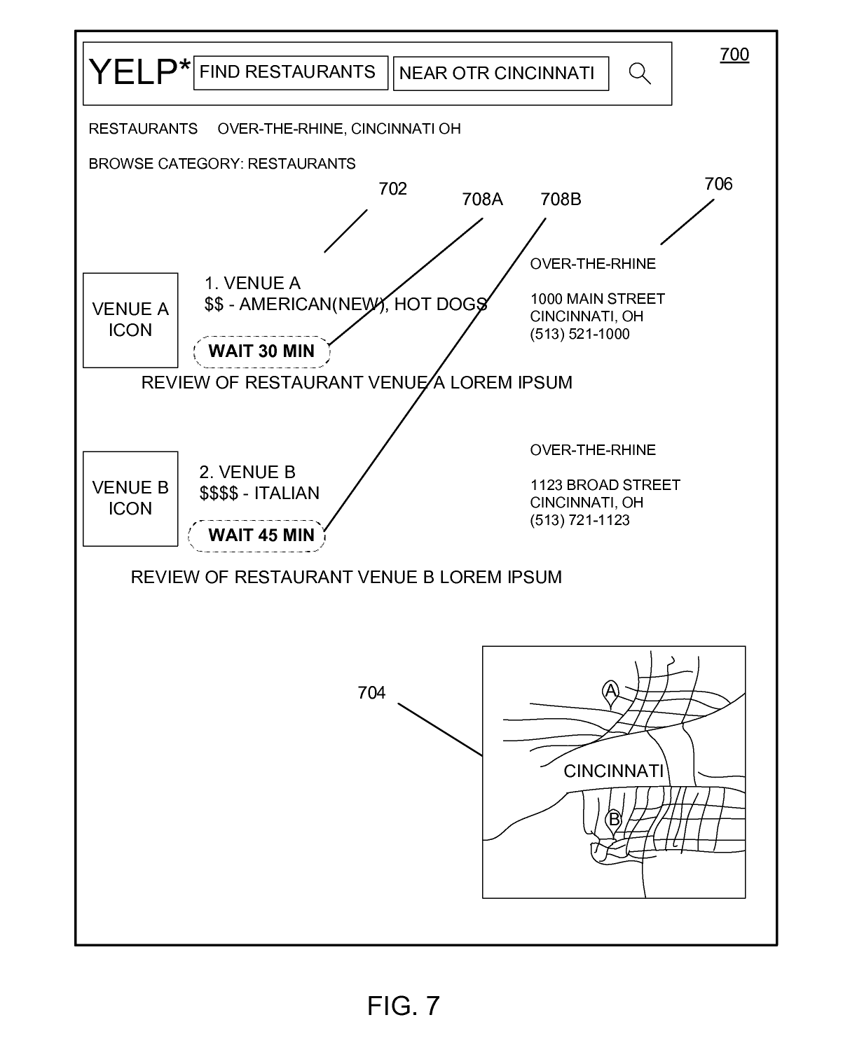

A user using an online guide such as Yelp™ to identify desired restaurants within a given neighborhood can be presented with the results of the search that also include an estimated wait range when known for a restaurant included in the results. Referring now to FIG. 7, an example of a supplemented search result is presented. In this example, a user has searched Yelp™ for restaurants in a particular area of a city. Yelp™ has returned as results a list of restaurants 702 that are in the area as well as a map 704 and addresses 706 for each matching result. The search/query API 312 can supplement the results of the search with wait time information 708A, 708B from the estimate module 306 for each of the restaurants 702. The search results can include the supplemental wait time information 708A, 708B in the results.

Similarly, a user of an online reservation system such as OpenTable™ can browse for available reservations on a mobile device, their home computer, or on a dedicated device such as a kiosk, and can be presented with the similar wait time information for the viewed restaurants. A wait time management system can be installed at particular establishments and can query a crowdsourced database using the wait management computing system 300 to determine and quote wait times to waiting customers for nearby sister establishments. A portable device such as a pager can be provided to patrons of an establishment and, either directly or through a central system, can query wait time information from a wait management computing system 300 and present the wait time information to the patron.

The wait management computing system 300 can include an advertising module 308. The advertising module 308 can have one or more algorithms that allocate advertising for user consumption. The advertising module 308 can use any suitable factor such as inputs of number of entries, time, reported or calculated wait times, dollars spent on advertisements, or advertisements dispensed. In an example configuration, the advertising module 308 can weigh occurrences of successfully submitted crowd reported data in combination with purchased advertising criteria and wait time information to allocate paid and incentive advertising. In an example, an establishment might buy $100.00 of banner advertising to appear on users' devices whenever the establishment's reported wait time is less than 10 minutes. This can be noted in the advertising module 308 as 100 points. At a competitor's establishment, users might report ten wait times which might reward that establishment points, for example 10 points. However, no wait times from users may be reported for the establishment that purchased the advertising. The advertising module 308 may then send advertisements to users' smartphones based on the proportion of points an establishment has earned or purchased versus the total of all points allocated along with any considerations (such as reported wait time being less than 10 minutes). In this case the purchasing establishment would have 100/(100+10) of the advertisements as determined and sent by the advertising module 308. The non-purchasing establishment would have 10/(100+10) of the advertisements as determined and sent by the advertising module 308. A point can then be subtracted each time an advertisement is served on behalf of a particular establishment until all points are used and corresponding advertisements sent. This can motivate organization owners to contribute to the collection of data. It can also influence behavior in users. The advertising module 308 can provide messaging, for example through the user interface 302, that can influence user behavior, especially in tandem with the provided estimates of wait times using crowdsourced and/or historical wait time information.

The wait management computing system 300 can include a reward module 314. The reward module 314 can track a user's successfully submitted data and other related data such as location. The user can be rewarded with various monetary and non-monetary incentives, such as badges, gift certificates, offers, and so forth based on these submissions. The reward module can use one or more algorithms. For example, a gaming algorithm can be used to attempt to increase the use of the wait time management system by users. Output from the gaming algorithm can be shared with other users to create a sense of accomplishment and competition. For example, a user may report 10 wait times for his favorite bar over a 4 week period. This might earn him the badge “Top Reporter” for that particular establishment. The user is also able to see the number of reports and the users making those reports for the same establishment so he remains competitively motivated to continue frequenting the establishment and reporting wait times. In another example, users can be entered into a raffle each week for a $100 gift card based on the number of wait times they report wait times for the prior week. In another example, reported wait times for a participating establishment can be tallied by user for a period of time such as a month. After the month is over, the user that provided the most reports can be rewarded with the ability to skip the wait, or advance to the front of the line, at the participating establishment on their next visit. Other rewards and promotions as would be understood in the art can similarly be offered. Reward module 314 similarly can reward the owners of a venue with incentive advertising based on crowd reporting for their venue.

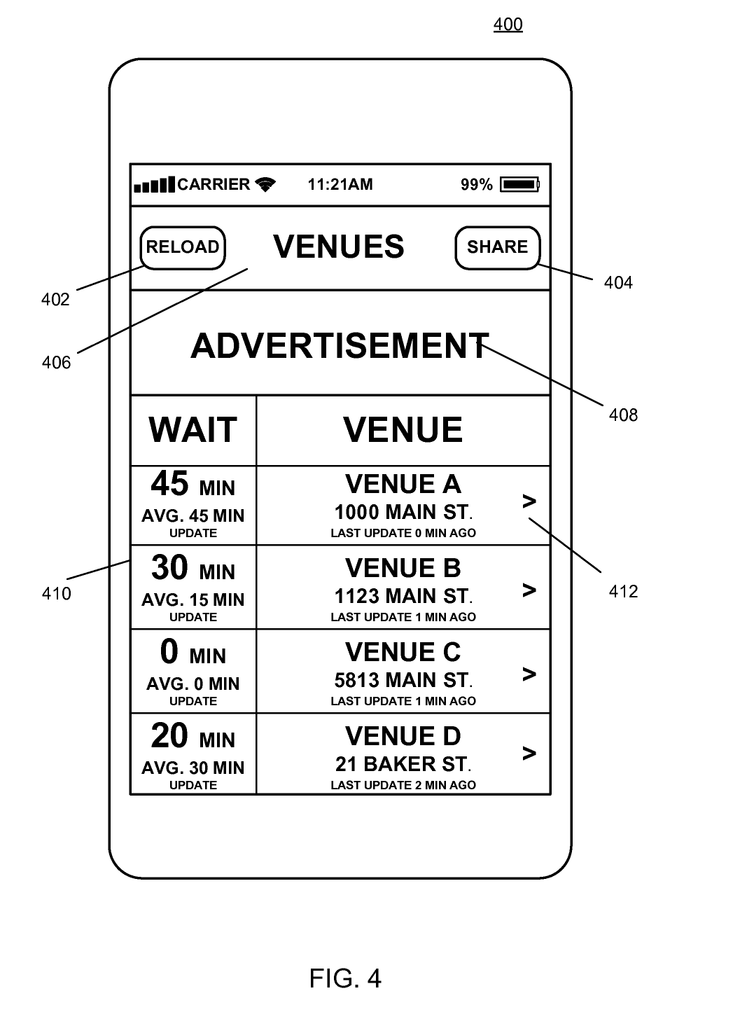

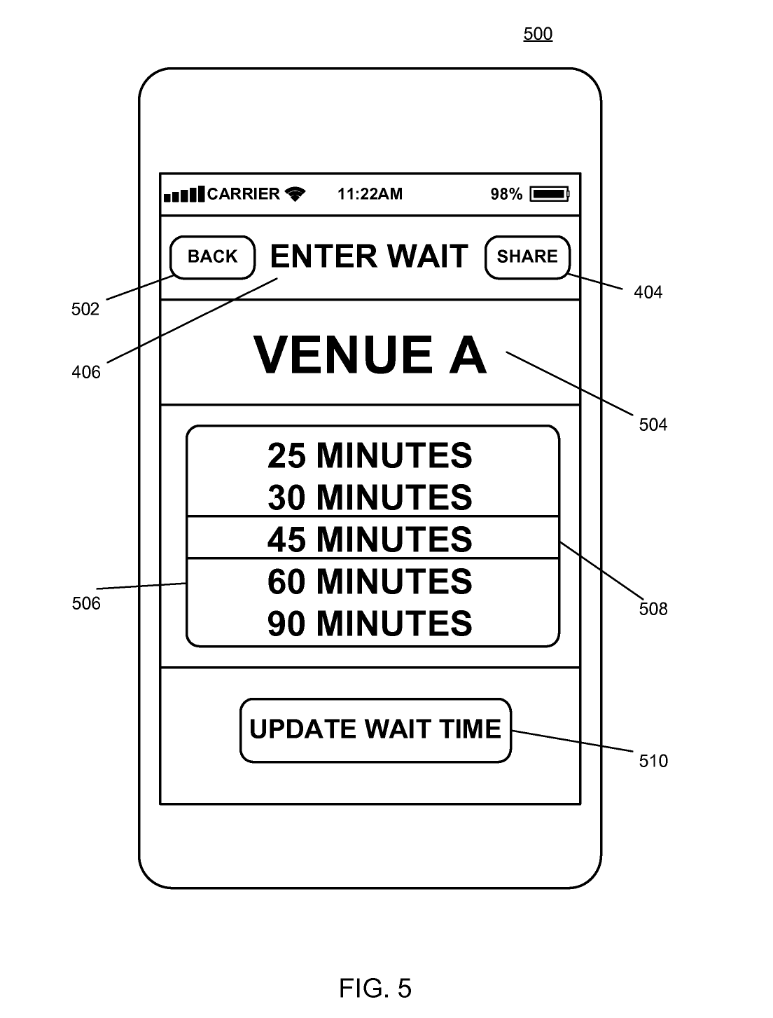

Referring now also to FIGS. 4 and 5, example user interfaces 400, 500 for a mobile app are presented. In an example scenario a user can enter a venue or establishment, such as a bar, restaurant, or the like, that is experiencing a wait. The user can open a mobile app associated with the wait management computing system 300 on a smartphone, or other suitable device. The user can search for and select the venue using the mobile app. In a configuration, the wait management computing system 300 can use position data available from the mobile computing device to determine the venue or, based on the position data, to determine a group of venues from which one venue can be selected by the user. The group of venues can be sorted and selected based on any factors described above, for example the group can be selected based on preferences configured by the user. As illustrated in the example of FIG. 4, the mobile app presents the user with a user interface 400 that shows a list 410 of venues that are proximate to the user and that have estimated wait times between 0 and 60 minutes. The list 410 can include the names of venues, the addresses of the listed venues, the current estimated wait time, as well as the average wait times for the same venues for the same day of the week and time. The list 410 can also include the last time that the wait times were updated. Other information can also be presented.

The user interface 400 can further include a screen title 406, a reload button 402 to refresh the list 410, a share button 404, and an advertisement 408. The share button 404 in the user interface 400 allows the share information with other users using social media, as is further described below. The advertisement 408 can present the user with a banner advertisement, or other notification, for a restaurant in close proximity to the user's location that, for example, may not have a wait and may offer a discount or free menu item to attract the user. The advertisement 408 can be determined by the advertising module 308 of FIG. 3. The advertising module 308 can use GPS or other position data, user input geographic information such as a “check in”, or other data to tailor deals or other content to a user related to a specific location. In an example configuration, the user can also receive a message from an establishment that is specifically sent because a long wait time was reported for the venue. The message can advise the user to visit the establishment on an alternate time or date when wait times are typically less.

The user can select a selected venue 412 from the user interface 400. The user can also search for, or manually enter, the name of a particular venue. The user is then presented with a different user interface 500 that allows the user to denote the wait time for the selected venue. The user interface 500 can show a screen title 406, the name of the selected venue 504, illustrated as “Venue A” in FIG. 5, and a set of scrollable wait times 506 from which a selected wait time 508 can be selected. The user can send an indication of the wait time for the venue to the wait management computing system 300 by selecting the update wait time button 510. The user can select the back button 402 to return to a previous screen of the user interface 302, 400. A user can share the wait time for a selected venue 504 on social media by selecting the share button 404. For example, by selecting a selected wait time 508 and pressing the share button 404 the user can send a message to friends using social media about the wait encountered at the venue. The message can also include advertising and information about the wait management computing system 300 and can include, for example, a link for downloading the mobile app. Sharing or reporting an indication of the wait time can trigger the reward module 314 to issue a reward. The user can be informed they have been awarded a prize, token, or bonus, such as 10 points, for reporting a wait time, which can be used towards a prize such as a raffle, a free gift certificate, or any other suitable reward as describe above.

In an example embodiment, a user can interact with an establishment to manage, control, or speed up a wait time. A user can send requests or information related to an estimated or actual wait time and the user can receive corresponding information from an establishment or a plurality of establishments. Active management of wait times by the user can include making reservations at a future time and/or the establishment offering or confirming such a reservation. Active management can also include a user requesting their name be put in line in advance of their arrival and/or the establishment offering or confirming such a request. Active management can also include a call being initiated between the venue and the user. Confirmation by the venue can include the then current wait time information which is both conveyed to the querying user and input into the wait management system as a user input. In an example embodiment, a user can note a long wait at a particular establishment and can, through the user interface, send an SMS text message to the establishment requesting they immediately be placed in the queue at the establishment. In response to this request, the establishment can send a confirmation SMS text back to the requesting user that they have been placed in the queue in addition to noting the current wait time. In this manner, users can actively manage wait times by making reservations or using call-ahead or text-ahead seating in response to actual or estimated wait times all while the wait time system captures additional wait time data.

Data regarding wait times, or other suitable information, can be presented to a user in any suitable format. For example, rather than providing specific wait times, wait time data can be organized into bands or groups that can be presented to a user, such as a “short wait” or “long wait”. In an example configuration, wait times can be shown as long, moderate, or unlikely. In an example configuration, wait times can be further denoted by colors with probable “long” waits being colored red, “moderate” yellow, and “unlikely” green. In an example configuration the probable likelihood of a wait and its severity can be represented by a gauge, bar, heat map, or the like. In an example configuration, the high, low, and average reported wait times for establishments can be listed in a range for a particular day, time, time of year, or the like. In other configurations, symbols, icons, wording, sounds, or other indicators can used, such as a “thumbs up” for a 5 minute or less estimated wait, “thumbs down” for an estimated wait of greater than 30 minutes, and a “?” if the wait is estimated between 5 and 30 minutes. In configurations, estimated wait times can be shown as color coded markers on a map, where red can equate to waits at locations greater than 30 minutes, green can equate to waits of less than 5 minutes, and yellow can equate to waits between 5-30 minutes. In configurations, reported wait times can be revealed when the markers, establishment, or map are rolled over, scrolled over, or otherwise selected on the User Equipment 320. Estimated waits can be shown as groups or with other visual effects to show a magnitude of estimated wait times, and can be shown in conjunction with the precise estimated wait or the current reported wait time. It will be appreciated that any suitable designation, range, grouping, or indicator of wait time is contemplated. It will be appreciated that data can be presented in any suitable language and can be presented in any suitable manner, such as audibly for the visually impaired, and can be presented to accommodate disabilities.

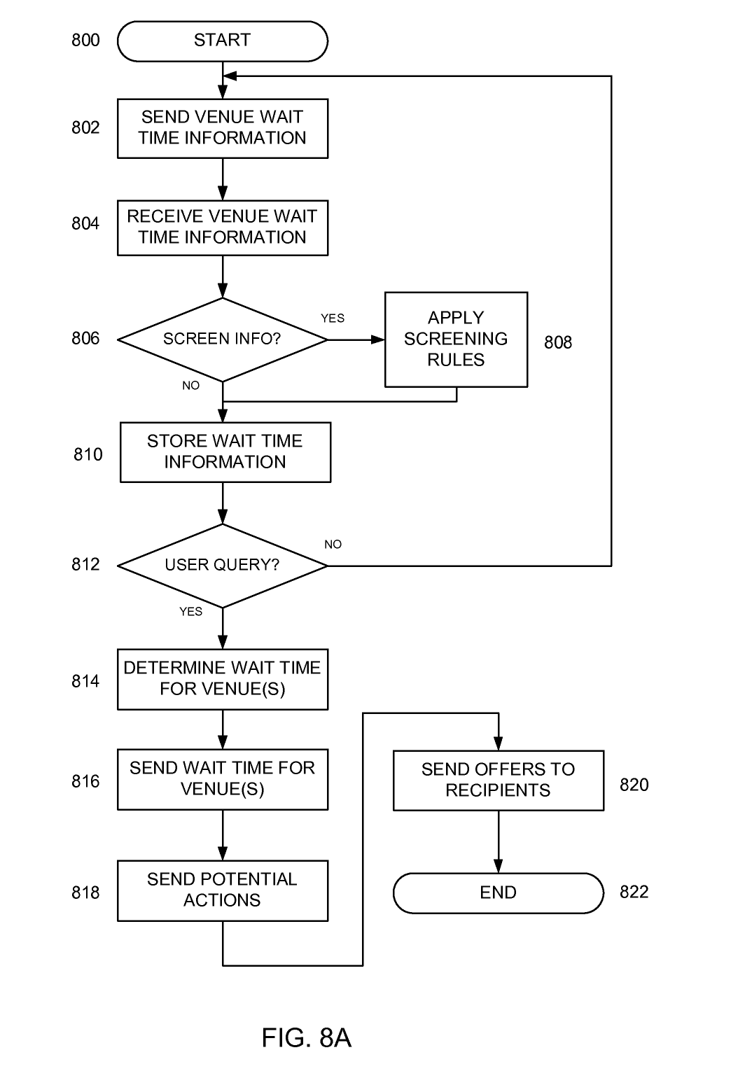

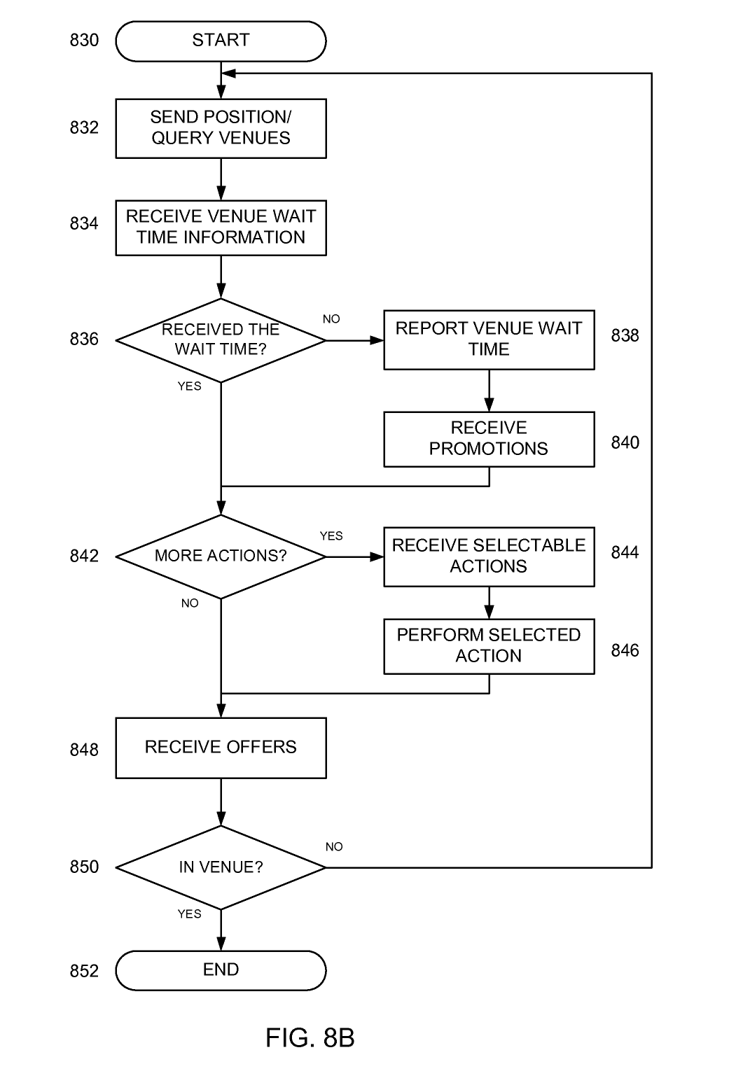

Referring now to FIGS. 8A and 8B, example flow diagrams of a crowdsourced wait time management system is presented. For the crowdsourced wait time management system, processing starts at start block 800 and continues to process block 802.

In process block 802, the crowdsourced wait time management system a user of the system sends wait time information for a venue, such as a restaurant, to the system. For example, a user can use an application running on a mobile computing device to select or input a wait time for a venue. In another configuration, the information can be entered or selected on a webpage. The application or webpage sends the wait time information associated with the venue to the crowdsourced wait time management system. This process can be performed by any number of users of the system. This process can be performed for any number or type of venues as described above and as would be understood by one of skill in the art. Processing continues to process block 804.

In process block 804, the crowdsourced wait time management system receives the wait time information for the venue from a user. The information can be received in any suitable data format, for example a data block or from data input by the user into a web page. Processing continues to decision block 806.

In decision block 806, the crowdsourced wait time management system can optionally screen the information provided by the user. If screening is performed, then processing continues to process block 808, otherwise processing continues to process block 810.

In process block 808, screening rules can be applied to the wait time information provided by the user. For example, the wait time information can be compared to historical norms for the venue, or compared to other wait time information provided by other users. The wait time information can also be screened based on position information, for example GPS (Global Positioning System) information or other positioning information provided by the mobile computing device or computing device that sent the information. The wait time information can also be screened based upon the identity of the user, or any other method as described above. Processing continues to process block 810.

In process block 810, the crowdsourced wait time management system can optionally store the wait time information. For example, the wait time information can be stored in a data store or database of the wait time management system. Processing continues to decision block 812.

In decision block 812, if the crowdsourced wait time management system receives a query from a user relating to a venue, then processing continues to process block 814, otherwise processing continues back to 802.

In process block 814, the crowdsourced wait time management system determines the wait time for the venue. As described above, the system can determine the wait time for a venue selected by a user. The system can also determine the wait times for other venues. In one example, the system determines wait times for similar venues to the one queried by the user. In another example, the system determines wait times for venues in proximity to the user or the queried venue. Proximity can be based upon any suitable factor, and can be adapted for the particular urban, suburban, or rural environment or venue. For example, for suburban environments, a restaurant within a mile or fractional of a mile could be configured in the system to be proximate to the selected venue. For city environments, being within approximately a city block, the same street, or an adjacent street might be configured in the system as proximate. For certain venues, proximity might be based on the nearest similar venues, for example in the case of license or motor vehicle departments. The determined wait times can be determined based upon stored crowdsourced wait time information, which can include historical wait time information and current wait time information. The wait times can also be estimated based on information obtained from third party sources. For example, current weather information, predicted weather forecasts, temperature, local scheduled activities, concerts, sporting events, reservation system information, transportation schedules, transportation data, economic data, news feeds, and social media postings and messages can be used to predict changes to the estimated wait times and can be used to alone or in conjunction with the stored crowdsourced wait time information. Processing continues to process block 816.

In process block 816, the crowdsourced wait time management system sends wait times for one or more venues to the user. The system can send the wait time just for the venue selected by the user. The system can send wait times for similar venues in proximity to the user or the selected venue. The system can send wait times for venues having shorter wait times. The wait time can be added to other information queried by the user as part of a response to the user. For example, as described above, a user can perform a Yelp™ or Google™ query and the wait time information can be associated with a venue appearing in the response and sent to the user as part of the response, for example it could be sent as part of the web page provided by Yelp™ or Google™ in the response to the query. The wait time information can thus be integrated into other systems, as described above. The system can also continue to send updates to wait times to users who have sent a query about a venue. Other conditions could be used to determine which wait times to send to the user as would be understood by one of skill in the art. Processing continues to process block 818.

In process block 818, the crowdsourced wait time management system optionally can send one or more potential actions for the venues to the user. In a configuration, the potential actions can be included with the wait time information of process block 816. Example potential actions can include sending information or links for performing communications directly with the venue, for example for placing a call to the venue, sending an instant message, and sending an email. Other potential actions can include actions that are mediated through the crowdsourced wait time management system. For example, the user may place a reservation, or ask to be placed on a wait list, by selecting a selectable action button on their mobile device. The selected action can be received by the crowdsourced wait time management system, and the crowdsourced wait time management system communicates directly with the venue on behalf of the user. Processing continues to process block 820

In process block 820, the crowdsourced wait time management system can send one or more offers to users of the system. For example, the user who queried the system about the selected venue can receive a promotional offer for the venue or a promotional offer from another venue in order to influence decision making as described above. For example, the user can receive a separate text message on their mobile device with an offer, such as a discount, coupon, voucher, or advertisement as described above. In another example, the venue can receive a promotional offer for using the crowdsourced wait time management service, also as described above. In another example, the users providing the wait time information can be offered a promotional offer for their part in providing wait time information to the crowdsourced wait time management system. Processing terminates at end block 822. For a user of crowdsourced wait time management system, processing starts at start block 830 and continues to process block 832. In process block 832, the user can query the crowdsourced wait time management system about a venue, or send geographic position information to the crowdsourced wait time management system in order to receive information about one or more venues nearby. Processing continues to process block 834.

In process block 834, the user can receive information about one or more venues, including the wait times at the venues, and other information such as the venues' names, locations, and hours of operation, and so forth. Processing continues to decision block 836.

In decision block 836, the user can compare the received wait time information for a venue, if any was provided in process block 834, with the actual wait time at the venue. If the received wait time information is inaccurate, or not available, then the user may desire to report the correct wait time and processing continues to process block 838, otherwise processing continues to decision block 842.

In process block 838, the user can report the wait time for a venue to the crowdsourced wait time management system. Processing continues to process block 840.

In process block 840, the user can receive a promotion for reporting the wait time, as described above. For example, the promotion can be reward credit, a discount coupon, or preferred placement onto the wait list. Processing continues to decision block 842.

In decision block 842, if the user desires to perform additional actions with a venue, then processing continues to process block 844, otherwise processing continues to process block 848.

In process block 844, the user can receive one or more selectable actions that can be performed with a venue. In a configuration, the user can receive the selectable actions with the received wait times in process block 834. Processing continue to process block 846.

In process block 846, the user can select or otherwise perform one of the actions. For example, as described above, actions can include calling the venue, texting the venue, emailing the venue, and otherwise communicating with the venue to request a reservation or request to be added to a wait list at the venue. Processing continues to process block 848.

In process block 848, the user can receive offers, such as promotional offers or other information, from the venue or from other venues. For example, as described above, a promotional offer can be a discount or coupon from another nearby venue to entice the user to visit the other venue. The offer can also be information about seating availability at another venue. The offer can also be information from the venue about available seating on another night. Other offers, promotions, and information can be sent to the user while the user awaits seating. Processing continues to decision block 850.

In decision block 852, if the user has been seated at a venue, or has gained admission to a venue, then processing can terminate at end block 852. For example, the user may end their use of the crowdsourced wait time management system once they are admitted or seated. Otherwise, processing can continue back to process block 832, or any other suitable process block, and the user can send additional queries or position information and receive updated wait time information.

Generally, the operations described in process blocks and decision blocks 800 through 852 can be performed in any order, as would be understood by one of ordinary skill in the art. For example, after receiving wait time information in process block 804, the system can send wait time information as described in process block 806 as an informational update to a user. Processing does not have to end at end block 820, but can continue in a loop starting with any suitable process block or decision block. Different users or entities can perform each of the operations of sending wait times to the crowdsourced wait time management system, receiving wait time estimates from the crowdsourced wait time management system, and receiving promotional offers.

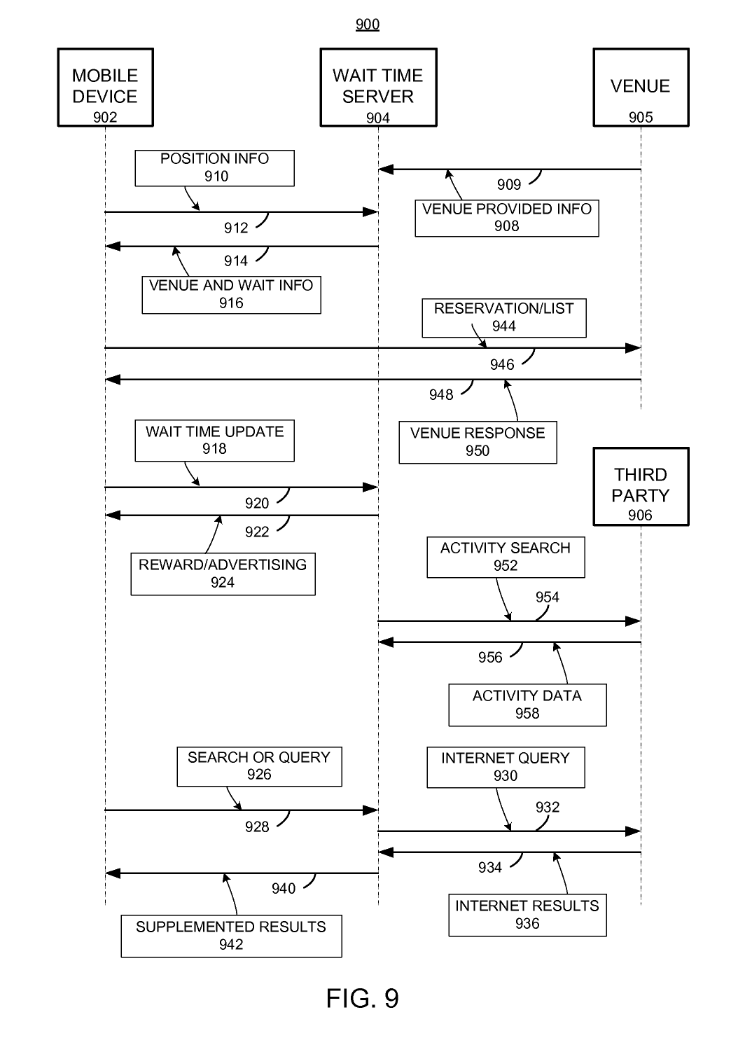

Referring now to FIG. 9, example communication flows 900 of a crowdsourced wait time management system are presented. A mobile device 902 can execute software, such as a mobile app, that opens a communication link 912 to a wait time management server 904 and sends current position data 910 for the mobile device 902. For example, the communication link can be an IP (Internet Protocol) communication channel and use UDP (User Datagram Protocol) or TCP (Transmission Control Protocol) messaging to send messages between the mobile device 902 and the wait time management server 904. The wait time management server 904 can process the position data 910 and send a response 916 to the mobile device 902. The wait time management server 904 can open a communication link 914 and send a response 916 that includes venue and wait time information as described above. In a configuration, communication links 912, 914 can be the same communication link. For example, if TCP/IP is used, once a communication link is established between the mobile device 902 and the wait time server 904, a new communication channel does not need to be established for future messaging. If a communication link is terminated or has timed out a new link may need to be established. In another configuration, communication links 912, 914 can be different communication links. For example, if UDP/IP is used, each communicated datagram can be considered to establish a new ephemeral communication link between the mobile device 902 and the wait time management server 904.

The response 916 to the mobile device 902 can include optional actions that a user can take. For example, the response 916 can include links for actions such as placing a call to the venue 905 or sending a message to the venue 905. In a configuration, the user of the mobile device 902 selects an action that sends a request 944 for a reservation, or to be added to the waitlist, over communication link 946. The venue 905 can receive the request 944 and send a response 950 to the mobile device 902 over a communication link 948. Example messaging can include text messaging, email, voice messaging, and so forth.

In another message flow, a venue 905, for example a manager or an employee of the venue 905 can establish a communication link 909 and send venue provided information 908 to the wait time management server 904. Examples of venue provided information 908 include, without limitations, the current wait time, future wait time estimates, immediate seating notifications, updates to opening or closing times, specials, coupons, and so forth.

In another message flow, a mobile device 902 can establish a communication link 920 and send a wait time update 918 to the wait time management server 904. The wait time management server 904 can respond that it has received the message (not shown), for example by sending a confirmation response or updating a sequence number to be sent with the next datagram. The wait time management server 904 can establish a communication link 922 with the mobile device 902 and send a message 924 with information about rewards earned by the user of the mobile device 902. The message 924 can include a promotional offer, coupon, or advertisement as described above.

In another message flow, a mobile device 902 can open a communication link 928 to the wait time management server 904 and send a message 926 that includes a search or query, for example an Internet search to be performed such as a Google™ search for a particular service, or a Yelp™ search for a particular establishment. The wait time management server 904 can receive the message and open a new communication link 932 across the Internet to a third party 906 such as Google™ or Yelp™. The wait time management server 904 can send the query 930 to the third party 906. The third party 906 can open a communication link 934, or use the existing communication link (not shown), and send results 936 from the query back to the wait time management server 904. The wait time management server 904 can search for venues in the results, for example by parsing the results or keyword searching. For venues found in the results, the wait time management server 904 can determine wait times for the venues and associate the wait time information with the venue information as described above. The wait time management server 904 can create supplemented search results that include the determined wait time information in the search results. The wait time management server 904 can open a communication link 940, or use an existing communication link (not shown), and send the supplemented results 942 to the mobile device 902.

In another message flow, the wait time management server 904 can open a communication link 954 to a third party 906 and search for local activity 952 such as weather information and forecasts, sporting and other events, reservation system information, and other information about locally occurring activities as discussed above. The wait time management server 904 can receive activity data 958 on a communications link 956 in response to the search for local activity 952. In a configuration, the wait time management server 904 also receives activity data 958 on a communications link 956 directly from third party 906 automatically without performing the search for local activity 952. For example, weather updates and social media postings can be received automatically from third parties 906. In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A computer-implemented method of providing wait time information, comprising:
receiving, from a first computing device associated with a first user, an indication of wait time at a venue;
receiving, from a second computing device associated with a second user, a query related to the venue;
determining wait time information for the venue based at least in part on the indication of wait time at the venue from the first user;
sending wait time information for the venue to the second computing device associated with the second user; and
offering, to at least one of the first user, the second user, or the venue, a promotional offer.

2. The computer-implemented method of claim 1, further comprising:
receiving, from a computing device associated with a third user, an indication of wait time at a second venue;
determining wait time information for the second venue based at least in part on the indication of wait time at the second venue from the third user; and
sending the wait time information for the second venue to the second computing device associated with the second user.

3. The computer-implemented method of claim 2, wherein the second venue is in proximity to the venue.

4. The computer-implemented method of claim 2, wherein the wait time of the second venue is less that the wait time of the venue.

5. The computer-implemented method of claim 1, further comprising:
sending wait time information for a plurality of other venues that each have at least one venue characteristic in common with the venue and that are each within a threshold proximity of the venue.

6. The computer-implemented method of claim 5, further comprising:
presenting, on the second computing device associated with the second user, one or more graphical display elements indicative of the wait time information for the venue and the plurality of other venues selected from the group consisting of
a color-coded representation of the wait time information,
a heat map graphical representation of the wait time information, and
a bar graph representation of the wait time information.

7. The computer-implemented method of claim 5, wherein the threshold proximity is selected from the group consisting of within approximately a mile of the venue, within a selectable fraction of a mile of the venue, within approximately a city block of the venue, on a same street as the venue, and on an adjoining street to the street of the venue.

8. The computer-implemented method of claim 1, wherein the venue is selected from the group consisting of a restaurant, a bar, an entertainment venue, a service provider, a repair shop, an automotive repair shop, a mechanic's shop, a shopping venue, a government agency, a bureau of motor vehicles, a security checkpoint, a service provider, a physician's office, an attorney's office, a transportation resource, a bus depot, a taxi stand, a ferry dock, an airport, an airline check-in counter, a subway stop, a subway line, a customer service provider, a computer help desk, a telephone support site, a software support site, a network provider, a retailer, and an online service center.

9. The computer-implemented method of claim 1, wherein determining wait time information further comprises:
obtaining stored user information about the first user; and
screening the indication of the wait time from the first user based at least in part on the stored user information about the first user.

10. The computer-implemented method of claim 1, wherein determining wait time information further comprises:
obtaining stored historical wait time information about the venue; and
determining wait time information for the venue based at least in part on the stored historical wait time information about the venue.

11. The computer-implemented method of claim 10, wherein the store historical wait time information includes a set of wait times from one or more users and wherein determining wait time information further comprises:
applying, to produce a set of screened wait times, at least one of
a screening algorithm to remove wait times associated with a particular user from the set of wait times,
a sigma bell curve algorithm to the plurality of wait times to remove wait times outside a selected distribution from the set of wait times, and
a decay algorithm to the plurality of wait times to remove wait times outside of a selected time window from the set of wait times; and
determining wait time information for the venue based at least in part on the set of screened wait times.

12. The computer-implemented method of claim 1, wherein determining wait time information further comprises:
obtaining, from a third party source, information that predictably impacts wait time at the venue; and
determining wait time information for the venue based at least in part on the information that predictably impacts wait time at the venue.

13. The computer-implemented method of claim 12, wherein the information that predictably impacts wait time at the venue is selected from one or more data of the group consisting of current weather information, weather forecasts, temperature forecasts, local scheduled activities, concerts, sporting events, reservation system information, transportation schedules, transportation data, economic data, news feeds, and social media postings and messages.

14. The computer-implemented method of claim 1, further comprising:
selecting, by a first user, a wait time for the venue from a selectable list of wait times; and
sending the indication of wait time at the venue, the indication of wait time includes the wait time selected from the selectable lists of wait times.

15. A computer-implemented method of providing wait time information, comprising:
receiving, from a computing device associated with a user, a query related to at least one venue;
obtaining venue information responsive to the query;
determining the identity of at least one venue from the venue information;
obtaining wait time information for at least one venue identified in the determining operation;
associating wait time information with the venue information; and
sending the venue information and associated wait time information to the computing device associated with the user.

16. A non-transitory computer readable medium having instructions stored thereon that when executed by one or more processors causes the processors to:
receive wait time information about a venue from a plurality of users of a crowdsourced wait time management service;
receive, from a user, a query about a current wait time for the venue;
determine the current wait time for the venue based at least in part on the wait time information from at least a subset of the plurality of users;
send, to the user, the current wait time for the venue; and
provide one or more action steps to the user related to the venue.

17. The non-transitory computer readable medium of claim 16, wherein the instructions further cause the one or more processors to:
receive, from the user, an indication of a selected action step;
send, to the venue, a message relating to the selected action step;
receive, from the venue, a confirmation message regarding the selected action step; and
send, to the user, confirmation by the venue of the selected action step.

18. The non-transitory computer readable medium of claim 17, wherein the selected action step is selected from the group consisting of
a request for a reservation for the user at the venue, and
a request to place the user on a wait list at the venue.

19. The non-transitory computer readable medium of claim 16, wherein at least one of the one or more action steps is configured to allow the user to communicate with the venue to perform one or more of
making a reservation for the user at the venue,
placing the user on a wait list at the venue, and
initiating a phone call between the user and venue.

20. The non-transitory computer readable medium of claim 19, wherein communications between the venue and user are performed directly without using the crowdsourced wait time management service.
